(19) United States
(12) Patent Application Publication
(10) Pub. No.: US 2005/0160186 A1
(43) Pub. Date: Jul. 21, 2005

(54) Optical display link

(76) Inventor: Everardo D. Ruiz, Beaverton, OR (US)

Correspondence Address: BUCKLEY, MASCHOFF, TALWALKAR LLC, 5 ELM STREET, NEW CANAAN, CT, 06840, US

(21) Appl. No.: 10/750,202

(22) Filed: Dec. 31, 2003

(51) Int. Cl. G06F 3/00

(52) U.S. Cl. 710/1

(57) ABSTRACT

According to some embodiments, multi-level symbol encoding may be used to provide display data through an optical link.

### BACKGROUND

In some cases, information from one portion of an electronic device may need to be provided to another portion of the device (or to an external device). For example, a processor in a mobile computer may need to provide display information to a display device. As the amount of information and/or the rate at which the information is provided increases, some approaches to provide the information may become impractical.

### BRIEF DESCRIPTION OF THE DRAWINGS

FIG. 1 is a block diagram of a mobile computer.

FIG. 2 is a block diagram of an apparatus according to some embodiments.

FIG. 3 is an example of multi-level amplitude encoding and decoding according to some embodiments.

FIG. 4 is a flow chart of a method according to some embodiments.

FIG. 5 is an example of a mobile computer according to some embodiments.

FIG. 6 is an example of a system according to some embodiments.

### DETAILED DESCRIPTION

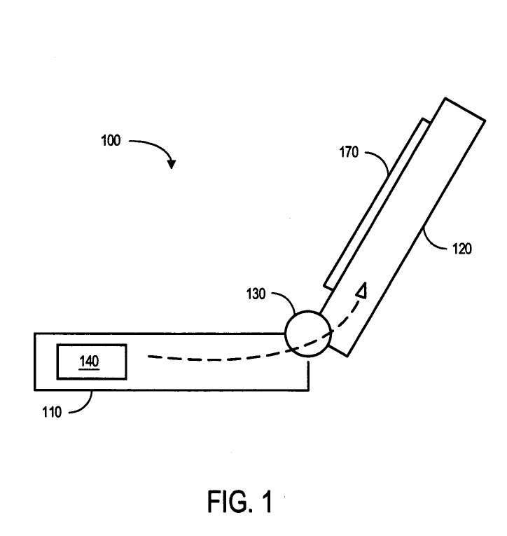

Information from one portion of an electronic device may need to be provided to another portion of the device. For example, FIG. 1 is a block diagram of a mobile computer 100 having a first portion 110 that might include a keyboard and one or more processing elements 140 (e.g., a microprocessor and an associated chipset). A second portion 120 of the computer 100 might include a display device 170, such as a Liquid-Crystal Display (LCD) panel. Moreover, the first portion 110 and the second portion 120 may be movable coupled by one or more hinges 130 (e.g., so that the mobile computer 100 can be opened and closed by a user). As illustrated by the dashed arrow, information from the first portion 110 (e.g., display data generated by the processing element 140) may be provided through the hinge 130 to the second portion 120 (e.g., to be displayed by the display device 170).

In one approach, electrically conductive paths (e.g., copper wires) are used to link the first portion 110 to the second portion 120. For example, digital display information might be provided through multiple wires in accordance with the Low Voltage Differential Signaling (LVDS) interface as defined by the American National Standards Institute (ANSI) standard 644 entitled “Electrical Characteristics of Low Voltage Differential Signaling Interface Circuits” (1995).

Note that when the first portion 110 and the second portion 120 are movably coupled, one or more of the copper wires in the link might eventually break (e.g., because opening and closing the computer 100 will bend the wires back and forth). In addition, it can be difficult to route multiple wires through the hinge 130 (e.g., wires several millimeters in diameter may be hard to route through the hinge 130). Such problems may increase as mobile computers become smaller and/or as the coupling between the first portion 110 and the second portion 120 becomes more complex (e.g., a rotatable gimbaled hinge might be used to let the display device 170 rotate around more than one axis).

Moreover, as the amount of information and/or the rate at which the information is provided increases, such an approach may become impractical. For example, as display resolutions and color depths increase, the number of wires in the link may need to be increased (e.g., making it even more difficult to route the wires through the hinge 130). In addition, the link might generate electromagnetic interference that violates governmental regulations, such as those established by the Federal Communications Commission (FCC). Attempts to reduce interference (e.g., by using a dithered clock signal) can increase the complexity of the circuits that required to the support the link. Further, the amount of power required to provide information via an electrical link can be significant.

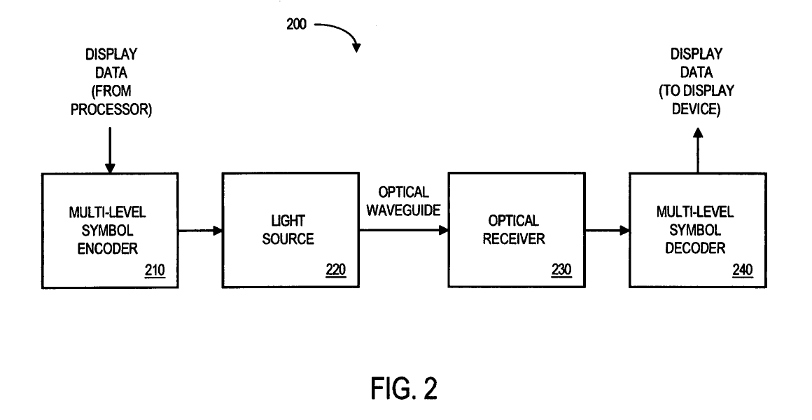

FIG. 2 is a block diagram of an apparatus 200 according to some embodiments. In this case, a multi-level symbol encoder 210 receives display data and generates multi-level symbols. For example, the symbol encoder 210 may include circuitry that receives LVDS display data from a chipset (e.g., the INTEL® 852GM chipset). Similarly, the symbol encoder 210 might receive display data from a processor via a Graphics Array (GA) interface or a Digital Video Out (DVO) interface. According to other embodiments, the symbol encoder 210 may receive information directly from a memory unit.

The symbol encoder 210 uses multi-level encoding to convert multiple bits of display data into a single symbol. A light source 220 then uses light to transmit the symbol through an optical waveguide. For example, a laser diode (using direct or external modulation) may transmit the multi-level symbol through a dielectric filament (e.g., a fiber optic cable) and/or a planar waveguide (e.g., a flat film).

An optical receiver 230, such as an avalanche photodiode or Positive, Intrinsic, Negative (PIN) photodiode may translate the light signal back into an electrical current. A multi-level symbol decoder 240 may translate the symbol back into the original bits of display data and provide the information to a display device. Although particular devices have been described with respect to the optical link, other device may used instead, such as an Avalanche Photo Diode (APD), a traveling wave structure, and/or a non-liner device.

Thus, when the symbol encoder 210 and the light source 220 are in a first portion of a mobile computer and the optical receiver 230 and the symbol decoder 240 are in a second portion, the optical waveguide acts as a link between the two portions. Note that a fiber optical cable may be less likely to fail as compared to an electrical link (e.g., because such a cable is more flexible than a copper wire). Moreover, the amount of electromagnetic interference may be reduced or eliminated.

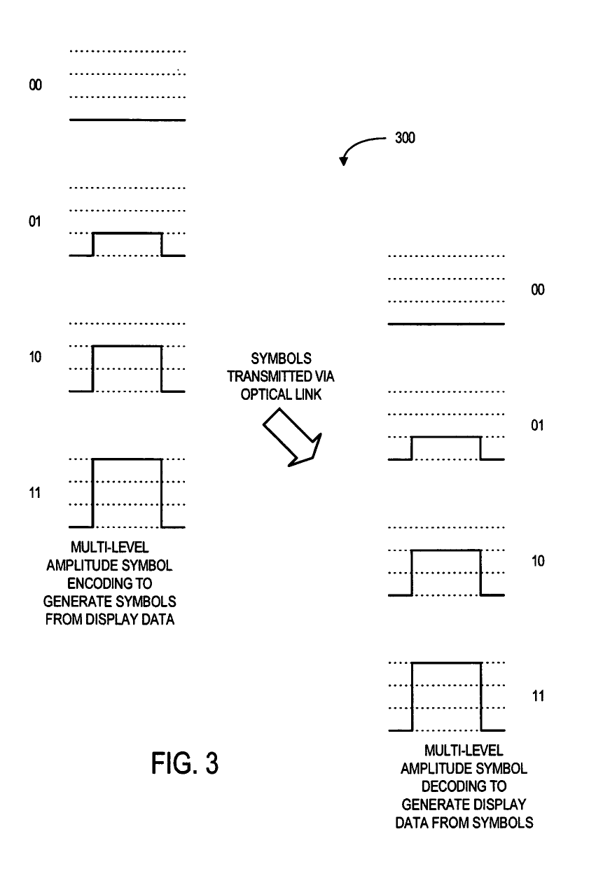

By using multi-level encoding and decoding, the rate at which information can be transmitted via the optical waveguide may be increased. For example, a single fiber optic cable might be able to replace multiple copper wires. FIG. 3 is an example of multi-level amplitude encoding and decoding according to some embodiments. In this case, two bits of display data are converted into a symbol having one of four different amplitudes (e.g., “00” might be converted into a first amplitude while “01” is converted into a second amplitude). The symbol is transmitted through the optical link and may then be converted back into the original two bits of display data. According to other embodiments, multi-level phase encoding is used to achieve a similar result, such as by encoding and decoding using Phase-Shift Keying (PSK) techniques. Similarly, binary encoding (e.g., “on-off” encoding), pulse width modulation, or any combination of encoding/decoding techniques may be used. Note that a four-level symbol is shown in FIG. 3 only as an example, and the encoding and decoding might be associated with other numbers of levels (e.g., eight-level encoding and decoding might be used).

When the length of the optical link may be relatively short (e.g., the link is providing information from a chipset to a display device in a mobile computer), the amount of fiber dispersion and optical loss in the link can be relatively small. As a result, low cost optical components (e.g., for the light source and/or the optical receiver) could potentially be used without degrading the quality of the display. In addition, the amount of power required to provide information via an optical link may be less than would be required for an electrical link.

Moreover, the relatively small amount of fiber dispersion and optical loss may cause the optical link's Signal to Noise Ratio (SNR) to be relatively high (e.g., higher than is needed). The use multi-level encoding and decoding, in effect, can trade the excess SNR in this situation for increased bandwidth—and may provide sufficient bandwidth for the display information to be transmitted using a single fiber optic cable.

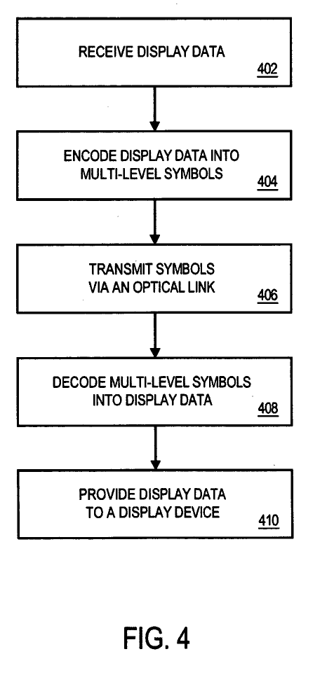

FIG. 4 is a flow chart of a method according to some embodiments. The flow charts described herein do not necessarily imply a fixed order to the actions, and embodiments may be performed in any order that is practicable. Note that any of the methods described herein may be performed by hardware (e.g., circuitry), software (including microcode), or a combination of hardware and software. For example, a storage medium may store thereon instructions that when executed by a machine result in performance according to any of the embodiments described herein.

At 402, display data is received. For example, multi-level phase encoding circuitry might receive LVDS display data from a chipset. The display data is then encoded into multi-level symbols at 404 (e.g., the circuitry might convert two bits of display data into a single symbol). The symbols are then transmitted via an optical link at 406 (e.g., via a single fiber optic cable) and are decoded back into the original display data at 408 (e.g., by multi-level phase decoding circuitry). At 410, the display data is then provided to a display device, such as an LCD panel.

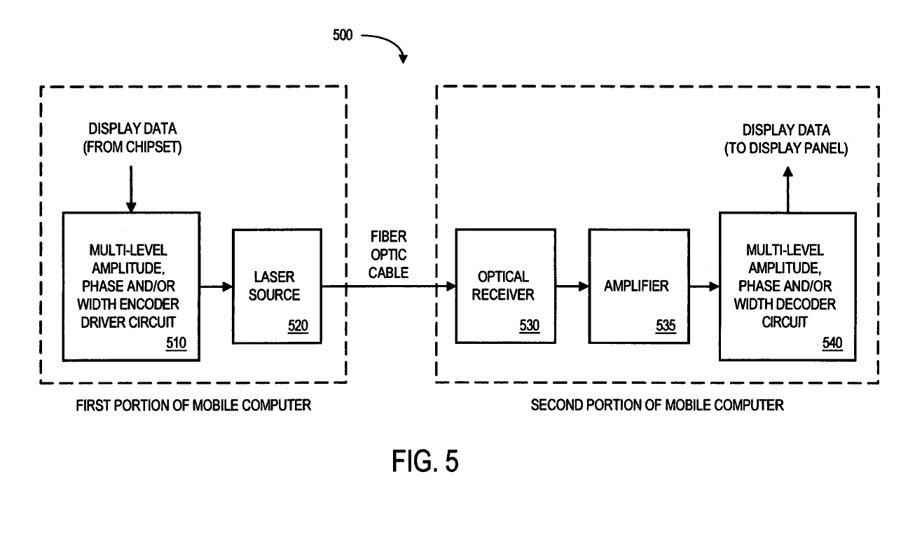

FIG. 5 is an example of a mobile computer 500 according to some embodiments. In this case, a multi-level amplitude and/or phase encoder driver circuit 510 receives display data and uses multi-level encoding to convert multiple bits of display data into a single symbol. A laser source 520 then uses light to transmit the symbol through a fiber optic cable.

An optical receiver 230, such as a PIN diode, may translate the received light signal into an electrical signal. An amplifier 535 may increase the electric signal and provide the amplified signal to a multi-level amplitude and/or phase decoder circuit 540—which in turn translates the symbol back into the original bits of display data and provides the information to a display panel.

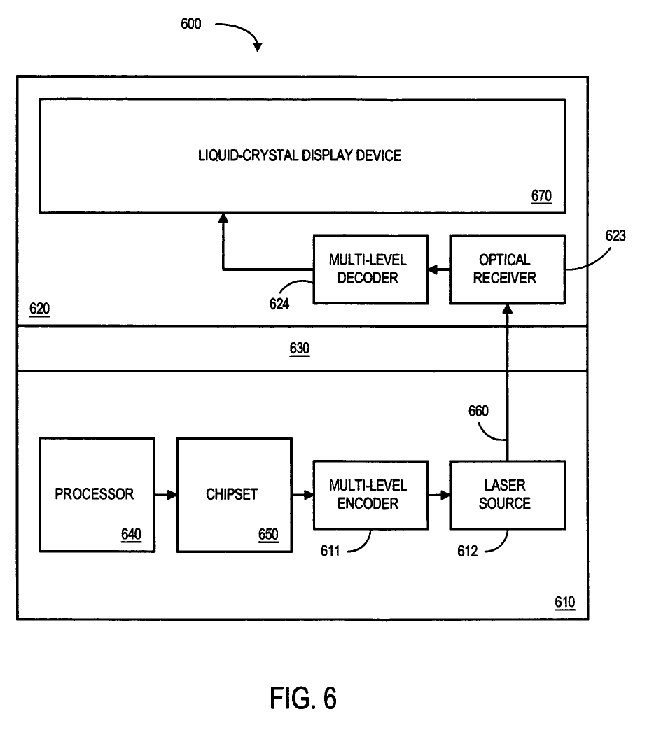

FIG. 6 is an example of a system 600 according to some embodiments. The system 600 includes a first portion 610 that houses a processor 640 and a chipset 650. Note that the first portion 610 might also house other components (e.g., a keyboard and a disk drive). The first portion 610 is movably coupled to a second portion 620 by a hinge 630. Note that the hinge 630 might also be, for example, a gimbaled hinge and/or a detachable coupling.

The first portion 610 also includes a multi-level encoder 611 that receives display data from the chipset 650 and provides symbol information to a laser source 612. The laser source 612 can then use light to transmit a multi-level symbol through a fiber optic cable 660. The fiber optic cable 660 carries the light through the hinge 630 and into the second portion 620.

The second portion 620 houses an optical receiver 623 that receives the light signal and generates an electrical signal. A multi-level decoder 624 may receive the electrical signal, translate the information, and provide the original display data to an LCD device 670.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described with respect to mobile computers, embodiments may also be used for other systems, such as desktop computers. Similarly, embodiments may be associated with wireless telephones, handheld computers, televisions (e.g., analog or high-definition digital televisions), game consoles, and/or audio devices. Moreover, the optical links disclosed herein may be used to provide information between any distributed portions of such devices.

Moreover, although some embodiments have been described with respect to display data, embodiments may also be used for other types of data. For example, a first portion of a mobile computer might house a processor while a second portion houses a peripheral interface, such as a Universal Serial Bus (USB) interface as described in the USB Specification Revision 2.0 (2000) or a 1394 interface as described in the Institute of Electrical and Electronics Engineers (IEEE) document 1394a (2000). In this case, an optical link and/or multi-level encoding may be used to provide information to the peripheral interface (e.g., to be eventually received by a printer).

While some embodiments have been described with respect to, for example, providing information from a processor to a display device, embodiments may be associated with bi-directional communication. For example, a display device or USB interface might also provide information to a processor or a chipset (e.g., via an optical or electrical link).

In addition, although some embodiments have been described with respect to an LCD display, embodiments may be used with any type of display, including a Light-Emitting Diode (LED) display device, a gas-plasma display device, a Cathode Ray Tube (CRT) display device, a field emission device, a flat panel device, and/or a passive transmissive device.

The several embodiments described herein are solely for the purpose of illustration. Persons skilled in the art will recognize from this description other embodiments may be practiced with modifications and alterations limited only by the claims.

1. An apparatus, comprising:
a multi-level symbol encoder to receive display data and to generate multi-level symbols;
an optical link coupled to the symbol encoder; and
a multi-level symbol decoder coupled to the optical link to receive the symbols and to re-create the display data.

2. The apparatus of claim 1, wherein the symbol encoder and the symbol decoder as associated with at least one of: (i) multi-level amplitude symbols, (ii) multi-level phase symbols, and (iii) multi-level pulse width symbols.

3. The apparatus of claim 1, wherein the optical link includes:
a light source coupled to the symbol encoder;
an optical waveguide coupled to the light source; and
an optical receiver coupled to the optical waveguide and to the symbol decoder.

4. The apparatus of claim 3, wherein the light source is a laser diode, the optical waveguide is a fiber optic cable, and the optical receiver is a positive, intrinsic, negative diode.

5. The apparatus of claim 3, wherein the apparatus further includes an amplifier coupled between the optical receiver and the symbol decoder.

6. The apparatus of claim 3, wherein the symbol encoder receives the display data from at least one of: (i) a processor, (ii) a chipset, (iii) a low voltage differential signaling interface, (iv) a graphics array interface, and (v) a digital video out interface.

7. The apparatus of claim 1, further comprising a display device to receive the display data from the symbol decoder.

8. The apparatus of claim 7, wherein the display device comprises one of: (i) a liquid-crystal display device, (ii) a light-emitting diode display device, (iii) a gas-plasma display device, (iv) a cathode ray tube display device, (v) a field emission device, (vi) a flat panel device, and/or (vii) a passive transmissive device.

9. The apparatus of claim 1, wherein the symbol encoder is housed in a first portion of a mobile computer, the symbol decoder is housed in a second portion of the mobile computer, and the first and second portions are movably coupled.

10. A method, comprising:
encoding display data into multi-level symbols;
transmitting the symbols via an optical link; and
decoding the symbols into the display data.

11. The method of claim 10, wherein the encoding and decoding are associated with at least one of: (i) multi-level amplitude symbols, (ii) multi-level phase symbols, and (iii) multi-level pulse width symbols.

12. The method of claim 10, further comprising:
receiving the display data.

13. The method of claim 10, wherein the display data is received from a chipset.

14. The method of claim 10, further comprising:
providing the display data to a display device.

15. An article, comprising:
a storage medium having stored thereon instructions that when executed by a machine result in the following:
encoding display data into multi-level symbols,
transmitting the symbols via an optical link, and
decoding the symbols into the display data.

16. The article of claim 15, wherein execution of the instructions further results in:
providing the display data to a display device.

17. An apparatus, comprising:
a first portion, the first portion housing:
a keyboard,
a processor, and
a multi-level symbol encoder to receive display data generated by the processor and to generate multi-level symbols; and
a second portion, the second portion housing:
a multi-level symbol decoder to receive the symbols and to re-create the display data, and
a display device to receive the re-created display data,
wherein an optical link couples to the symbol encoder and symbol decoder.

18. The apparatus of claim 17, wherein the first portion and the second portion are movably coupled.

19. The apparatus of claim 18, wherein the apparatus is a mobile computer.

20. A mobile computer, comprising:
a first portion, the first portion housing:
a processing device; and
a second portion, the second portion housing:
a display device,
wherein an optical link is to provide data from the processing device to the display device.

21. The apparatus of claim 20, wherein the first portion and the second portion are movably coupled.

22. A system, comprising:
a multi-level symbol encoder to receive display data and to generate multi-level symbols;
an optical link coupled to the symbol encoder;
a multi-level symbol decoder coupled to the optical link to receive the symbols and to re-create the display data; and
a liquid-crystal display device to receive the display from the symbol decoder.

23. The system of claim 22, wherein the optical link comprises:
a light source coupled to the symbol encoder;
an optical waveguide coupled to the light source; and
an optical receiver coupled to the optical waveguide and to the symbol decoder.

24. An apparatus, comprising:
a first portion, the first portion housing:
a processor, and
a multi-level symbol encoder to receive peripheral data and to generate multi-level symbols; and
a second portion, the second portion housing:
a multi-level symbol decoder to receive the symbols and to re-create the peripheral data, and
a peripheral interface,
wherein an optical link couples to the symbol encoder and symbol decoder.

25. The apparatus of claim 24, wherein the first portion and the second portion are movably coupled.

26. The apparatus of claim 25, wherein the apparatus is mobile computer.

27. The apparatus of claim 26, wherein the peripheral interface is associated with a universal serial bus.
